(19) United States
(12) Patent Application Publication
(10) Pub. No.: US 2006/0020720 A1
(43) Pub. Date: Jan. 26, 2006

(54) Multi-controller IO shipping

(75) Inventors: David Stallmo, Boulder, CO (US); Brian McKean, Longmont, CO (US); Ross Zwisler, Boulder, CO (US)

Correspondence Address: LSI LOGIC CORPORATION, 1621 BARBER LANE, MS: D-106, MILPITAS, CA, 95035, US

(73) Assignee: LSI Logic Corporation, Milpitas, CA (US)

(21) Appl. No.: 10/897,526

(22) Filed: Jul. 23, 2004

(51) Int. Cl. G06F 13/14

(52) U.S. Cl. 710/36

(57) ABSTRACT

A system and method for communication amongst a device and multiple controllers. A controller may use a direct communication path to the device or may route the communication to another controller that has a faster communication path to the device. Such a system and method is particularly useful when the device takes a long time to switch from a communication path with the second controller to a communication path with the first controller.

### BACKGROUND OF THE INVENTION

a. Field of the Invention

The present invention pertains generally to architectures with devices having multiple communication ports and specifically to communications within the architectures.

b. Description of the Background

In many electronic systems, two or more controllers may communicate with a specific device. In some cases, the specific device may not have the bandwidth to communicate with all of the controllers simultaneously. The device may be further limited by only being able to handle one communication path at a time.

A problem arises when one communication path is faster than the other, since the controller connected to the slower connection must take additional time to communicate with the device. This can happen in two situations: where the device has two ports and one port is faster than the other, and where the device has several ports but requires a long switching time to switch from one port to another.

When the device takes a substantial amount of time to switch from one communication path to another, the controller connected to the switched off port will suffer a longer communication time. For shorter communications, the switching time may become a substantial portion of the time required for the communication to occur and the overall performance of the system may suffer substantially.

For example, a multi-disk storage system may have two or more internal controllers that are each capable of communicating with a disk. The disk may have communication paths to each controller that must be configured or switched prior to communicating with a specific controller. After one controller has finished communicating, a second controller must cause the disk to switch ports so that the second controller may send a message. If the switching operation is time consuming and performed very often, the overall performance of the system will degrade.

It would therefore be advantageous to provide a system and method whereby multiple controllers may communicate with a single device without suffering significant performance degradation. It would be further advantageous if such system and method could be implemented without significant cost increases to the overall system.

### SUMMARY OF THE INVENTION

The present invention overcomes the disadvantages and limitations of previous solutions by providing a system and method for communication amongst a device connected to multiple controllers. A controller may use a direct communication path to the device or may route the communication to another controller that has a faster communication path to the device. Such a system and method is particularly useful when the device takes a long time to switch from a communication path with the second controller to a communication path with the first controller.

An embodiment of the present invention may include a system comprising: a first controller; a second controller connected to a first communication path to the first controller; a device having a plurality of ports, a first port being connected to the first controller along a second path and a second port being connected to the second controller along a third path, the device being configured to communicate along the third path and requiring a configuration time to communicate along the second path; wherein the first controller is adapted to determine that the device is configured to communicate along the third path, the first controller being further adapted to send a message to the device along the second path or the first and third paths using a predetermined criteria.

Another embodiment of the present invention may include a disk storage system comprising: at least one disk drive having multiple ports and being capable of communicating on one port at a time, the disk drive requiring a changeover time to switch from a first of the ports to a second of the ports; a first controller connected to the first port of the disk drive through a first path; a second controller connected to the second port of the disk drive through a second path and connected to the first controller through a third path, the second controller adapted to detect that the disk drive is switched to the first path and send a message to the disk drive through the third path and the first path based at least in part on a predetermined criteria.

Yet another embodiment of the present invention may include a method for communicating from a first controller to a device having a first communication path to the first controller and a second communication path to a second controller, the first controller having a third communication path to the second controller, the method comprising: determining that the device has a switchover time to switch from the second path to the first path; determining that the device is switched to the second path; evaluating a first message to send; sending the first message to the device via the third path and the second path.

The advantages of the present invention are that the overall performance of a system having multiple controllers may be optimized for communications to a device. The system may use lower cost devices that do not include fast switching without suffering degradation in performance.

### BRIEF DESCRIPTION OF THE DRAWINGS

In the drawings,

FIG. 1 is a diagrammatic illustration of an embodiment of the present invention showing a multi-controller system with several devices.

FIG. 2 is a diagrammatic illustration of an embodiment of the present invention showing a multi-controller communication system with a switch thrown to one controller.

FIG. 3 is a diagrammatic illustration of an embodiment of the present invention showing a multi-controller communication system having an I/O manager layer.

FIG. 4 is a diagrammatic illustration of an embodiment of the present invention showing a multi-controller system using a mirrored cache.

FIG. 5 is a flowchart illustration of an embodiment of the present invention showing a method for communicating.

### DETAILED DESCRIPTION OF THE INVENTION

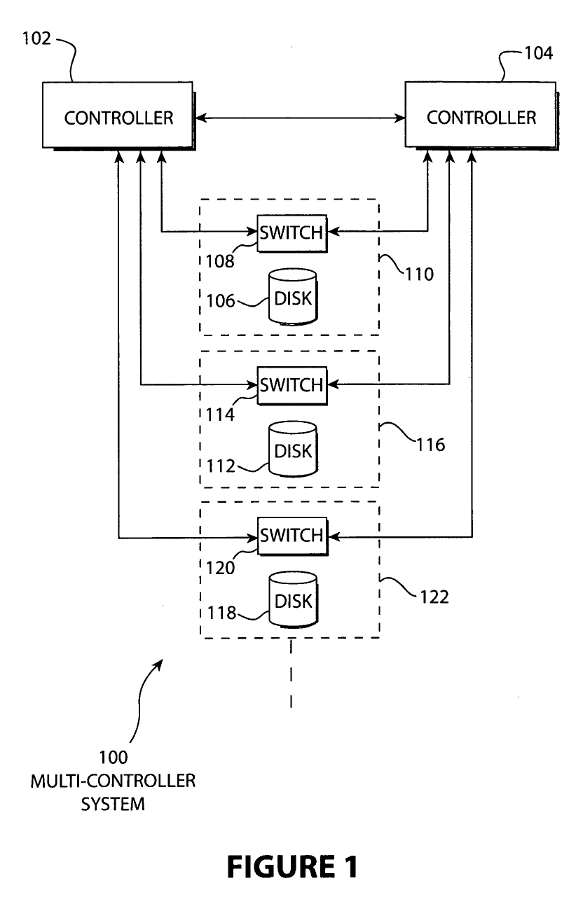

FIG. 1 illustrates an embodiment 100 of the present invention showing a multi-controller system. Controllers 102 and 104 are able to communicate with disk 106 through switch 108. The disk 106 and switch 108 may be mounted as a single unit 110. Similarly, controllers 102 and 104 are able to communicate to disks 112 and 118 through switches 114 and 120, respectively. Disk 112 and switch 114 may be a single unit 116 as disk 118 and switch 120 may be a single unit 122.

The embodiment 100 may be a disk storage system wherein controllers 102 and 104 are able to communicate and control the disks 106, 112, and 118. Such a system may be used in a redundant array of independent disks (RAID) system or other mass storage systems. Embodiments incorporating disk drives are used in this specification to exemplify the present invention, but those skilled in the art will appreciate that various other systems and devices may be used in other embodiments of the invention. The invention is expressly not limited to embodiments containing disk drives.

The devices 110, 116, and 122 may be dual ported devices. In other words, the devices 110, 116, and 122 may be operated by either controller 102 or 104. This capability has several advantages, such as redundancy in the case of a controller failure, load balancing, or the capacity to handle requests from multiple sources.

Some devices are designed with dual port capability while others may not be. Those without dual ports may simulate dual port devices with the addition of a switch, sometimes called an interposer. In embodiment 100, the disks 106, 112, and 118 may be single ported devices to which have been added switches 108, 114, and 120 to make the devices 110, 116, and 122 replicate the function of dual ported devices.

Devices with designed-in dual port capability tend to be more expensive than single ported devices, because of the additional cost and complexity of the dual port features. However, such devices tend to perform faster than the combination of a lower cost single ported device with a separate interposer or switch.

Specifically, a separate switch, interposer, or path controller may require that a controller perform some function to cause the switch to change from one port to another. In some cases, the controllers 102 or 104 may not have to expressly configure the switches 108, 114, or 120 to change from one position to another, but the switches 108, 114, or 120 may require a certain amount of overhead time to switch from one port to another.

When the switching time becomes high, the time required to send messages may have adverse consequences on performance. For example, if the switching time is 10 ms and the message length is only 10 ms, fully 50% of the transmission time is devoted to switching.

When a switch 108, 114, or 120 is set to communicate with one of the controllers 102 or 104, that controller can communicate to the respective disk quickly and directly without any switching time overhead. For the purposes of discussion, such a controller can be known as the primary controller. The secondary controller is the one to which the respective switch is not configured, and would require the overhead time of configuring the respective switch in order to communicate with the device.

In some circumstances, it may be advantageous for the secondary controller to communicate with a device by passing a message to the primary controller which then passes the message to the device. Such a situation may occur when the message length is very short and the switchover time is long.

In a typical scenario, a controller may determine that it is a secondary controller by determining that the device's switch is set to another port. The secondary controller may evaluate the message to see if it makes sense to cause the switch to change over to the secondary controller's port. If so, the secondary controller may cause the switch to change over and transmit the message. In some cases, the secondary controller may cause the switch to be reset to the primary controller immediately after transmitting the message.

When configuring the overall system of embodiment 100, the various devices 110, 116, and 122 may be set so that one of the controllers 102 or 104 is the primary controller. This action may be configured when the system is initialized or may be done on-the-fly.

In an RAID example, controller 102 may be assigned disks 106 and 118 while controller 104 may be assigned disk 112 for load balancing purposes. Thus, controller 102 would be the primary controller for disks 106 and 118 and would also be the secondary controller for disk 112. When a host sends a command intended for disk 106, that command may be routed to controller 102 by default. However, there may be some need for controller 104 to access disk 106 as a secondary controller. When secondary controller 104 has a long message to transmit to disk 106, controller 104 may cause switch 108 to change ports, execute the transmission, and cause switch 108 to change back to the previous setting. Otherwise for short transmissions, the secondary controller 104 may send the message to controller 102 to be sent to the disk 106.

The criteria for determining the route of the message may be to compare the time required to send the message via the primary controller to the time required for the direct transmission plus two times the switchover time. Two times the switchover time is used because the secondary controller resets the switch to the primary controller after each transmission.

Assigning controllers as primary and secondary may be useful in embodiments where one controller may be doing a bulk of the communication with the device and the communications from the secondary controller would be typically short or not time sensitive.

The controllers may also be configured without any special preference as primary or secondary. In such cases, each communication from a secondary controller to a device would be evaluated using different criteria than the previous example. The criteria may be to compare the time required to send the message via the primary controller to the time required to communicate directly with the device plus one times the switchover time. In this case, the secondary controller ends up as the primary controller of the device.

The embodiment 100 shows two controllers 102 and 104 attached to each device 110, 116, and 122. Those skilled in the art may appreciate that two or more controllers may connect to each device. Embodiments with three, four, one hundred, or more controllers are possible. Similarly, even though multiple devices are illustrated in the embodiment 100, embodiments with as few as one device 110 may be possible while keeping within the spirit and intent of the present invention.

The term ‘controller’ as used in this specification refers to any device that is capable of communicating with another device. The controller may incorporate a minimum of computational power and may execute software or firmware. In other cases, the logic contained in the controller may be hardwired. A controller, as used in this specification, is a device used to control the transfer of data from one place to the multi-ported device. A controller may be a single chip, a stand-alone device, or any other type of device that can control the transfer of data.

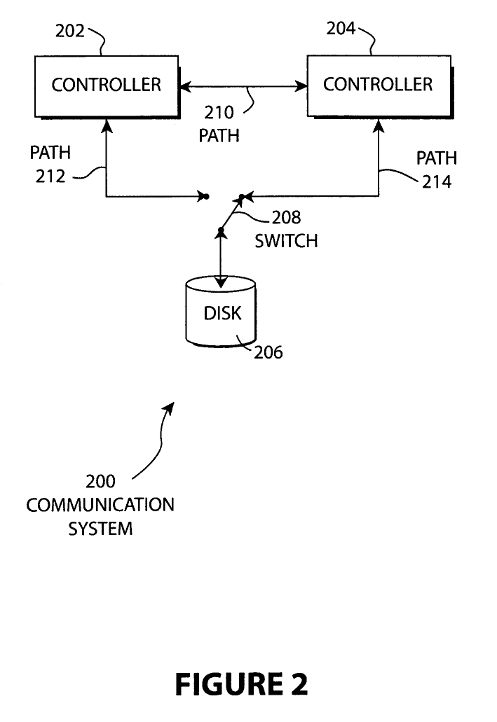

FIG. 2 illustrates an embodiment 200 of the present invention showing a communication system. Controllers 202 and 204 are capable of communicating with disk 206 through switch 208. Controllers 202 and 204 are connected by path 210. Controller 202 is connected to switch 208 by path 212. Similarly, controller 204 is connected to switch 208 by path 214.

In an embodiment of a RAID storage system, the controllers 202 and 204 may be connected by any type of high speed path 210. For example, path 210 may be a high speed serial communications protocol such as Fibre Channel, or may be a parallel protocol such as SCSI. In other cases, the path 210 may be a high speed proprietary communications channel.

The embodiment 200 illustrates a situation where switch 208 is set to communicate with the path 214 to controller 204. Thus, controller 204 is the primary controller and controller 202 is the secondary controller. When controller 202 wishes to communicate with disk 206, two options are available. The first option is to cause switch 208 to connect to path 212 and use path 212 to communicate directly to the disk 206. The second option is to send the message via path 210 to controller 204, then via path 214 to disk 206.

In some cases, the first option will be faster than the second, while in other cases, the second option will be faster. The controller 202 may evaluate the message to be sent and select the option that will be fastest. For example, when the switchover time is high and the message short, the second option may be favorable. Similarly, when the switchover time is short or the communication time over path 210 is long, the first option may be favorable.

The speed of path 210 and transfer time of controller 204 has a detrimental effect on communications between controller 202 and disk 206 when switch 208 is set to path 214. In embodiments where path 210 has a very high speed, it is often more advantageous to use paths 210 and 214 for communications between controller 202 and disk 206.

In some embodiments, the switch 208 may be caused to actuate through a separate communication channel. For example, the switch 208 may be controlled by the controllers 202 and 204 through a separate communication channel. A controller may send a request to the switch, wait for the switch to occur, and receive permission to transmit over the switched path. In another embodiment, the switch 208 may detect that a communication is pending on path 212, perform a switchover, and send permission to transmit to controller 202. Still other embodiments may have different methods for communicating with the switch 208 and the controllers 202 and 204 for the purposes of changing the switch 208.

In all the instances where the switch 208 must change from one position to another, a time delay may occur. When the time delay is longer than the time required to send a message via path 210 to controller 204, it may be faster to send a message via paths 210 and 214. Conversely when the switching time is very short, it may be faster to cause the switch 208 to activate and use path 212.

The message sent via paths 210 and 214 may consist of several communications in both directions to and from the device 206. For example, a request to read data may be sent via paths 210 and 214. The request may contain routing information that is attached to the data read from the device 206 and sent back vial paths 214 to the controller 204. The controller 204 may read the routing information and send the data to controller 202 via path 210. This is merely one manner in which two way communications may be sent over the present embodiment. Other techniques may be used for two way communications between controller 202 and disk 206 in the present embodiment while keeping within the spirit and intent of the present invention.

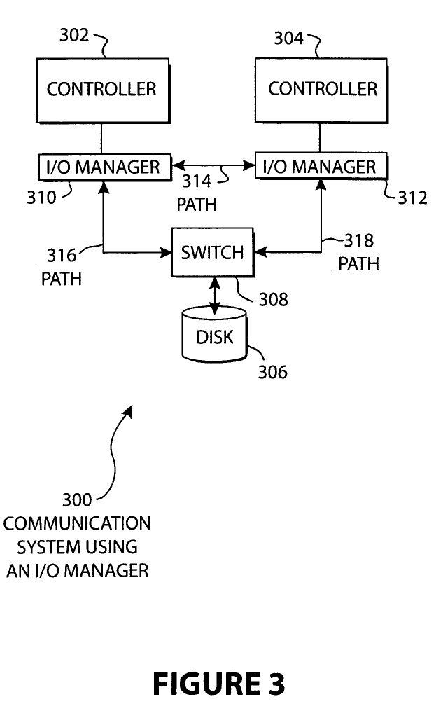

FIG. 3 illustrates an embodiment 300 of the present invention showing a communication system using an I/O manager. Controllers 302 and 304 are configured to communicate with disk 306 through switch 308. Controller 302 uses I/O manager 310 and controller 304 uses I/O manager 312. Path 314 connects the I/O managers 310 and 312. Path 316 connects I/O manager 310 with switch 308. Similarly, path 318 connects I/O manager 312 with switch 308.

The I/O managers 310 and 312 may be a layer that handles communications between the controllers 302 and 304, respectively, to the disk 306. The I/O managers 310 and 312 may perform the evaluation of the messages to be sent, cause the switch 308 to change states, and handle messages routed from the opposite I/O manager. The I/O managers may also perform the control and communication with the switch 308.

The I/O managers 310 and 312 may be transparent to the controllers 302 and 304. When a controller 302 or 304 sends a message to the disk 306, the I/O manager 310 or 312 may route the message to the disk without requiring the appropriate controller to manage the communication.

The I/O managers 310 and 312 may be a software layer, such as a driver, that operates within the controller 302 and 304. In other embodiments, the I/O managers 310 and 312 may have logic embedded in hardware or may be separate devices dedicated to handling the communication. Various embodiments are possible by those skilled in the arts.

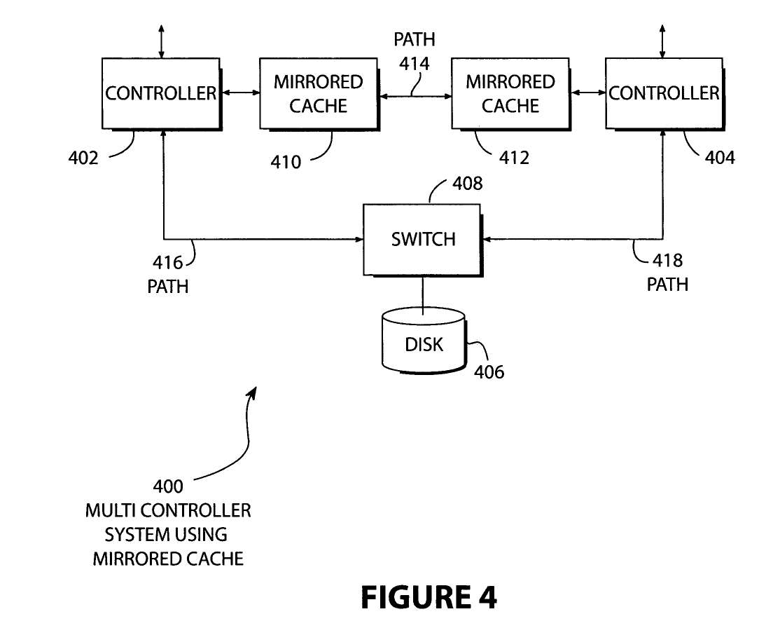

FIG. 4 illustrates an embodiment 400 of the present invention showing a multiple controller system using a mirrored cache. Controllers 402 and 404 are configured to communicate with disk 406. Mirrored caches 410 and 412 are connected by path 414 and are connected to controllers 402 and 404, respectively. Path 416 connects controller 402 to switch 408 as path 418 connects controller 404 and switch 408.

In many redundant systems using multiple redundant controllers, the cache within the respective controller is mirrored in another controller. This feature is sometimes used to recover in the event that one controller fails or goes off line. Typically, each command to be executed and the data to be transferred may be placed in the cache. If a controller is brought off line, the other controller may finish executing the off line controller's commands without losing any data.

The mirrored cache 410 and 412 are accessible to both controllers 402 and 404. When a message is to be sent to disk 406 from controller 402 and switch 408 is set to path 418, controller 402 may transfer the message to disk 406 by placing the message in a portion of the cache 410 normally dedicated to controller 404. The path 414 may update the cache 412 and cause controller 404 to execute the message.

The decision to transfer the message to disk 406 through the cache 410 is made by comparing the time required for the switch 408 to actuate with the time required for the message to transfer through paths 414 and 418.

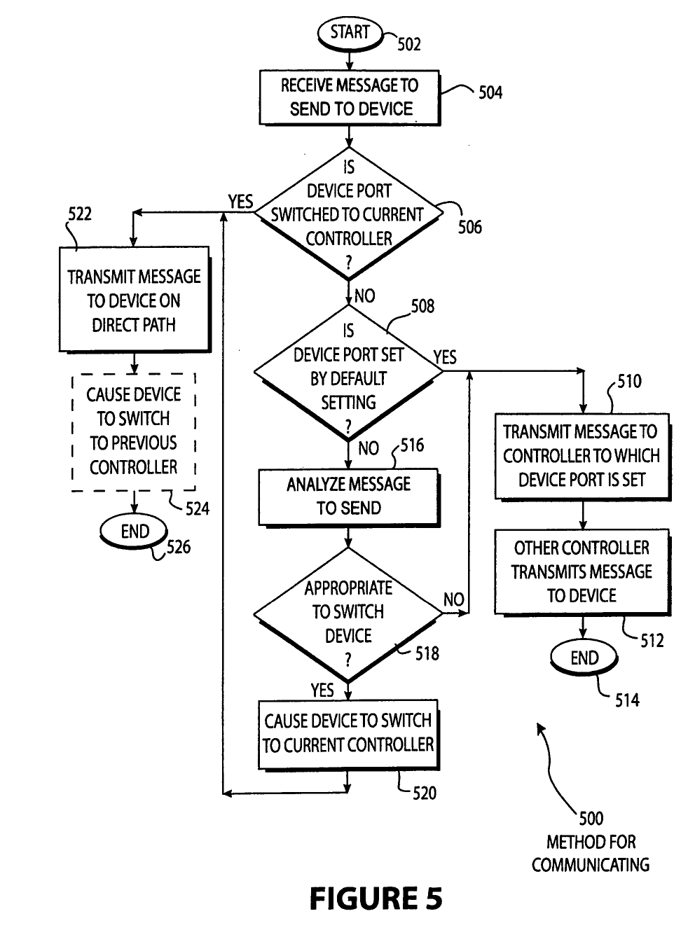

FIG. 5 illustrates an embodiment 500 of the present invention showing a method for communicating. The process starts in block 502 and a message is received in block 504. In block 506, a check is made of the switch status. If the switch is set to another controller in block 506, and the port is set by a default setting in block 508, the message is transmitted to the primary controller in block 510, transmitted to the device in block 512, and the process ends in block 514. If the default is not set in block 508, the message is analyzed in block 516. If it is not appropriate to activate the switch in block 518, the message is transmitted in block 510. If it is appropriate to activate the switch in block 518, the switch is activated in block 520. Once the switch is activated in block 520 or if the switch was previously activated in block 506, the message is transmitted directly in block 522, the switch is optionally reset in block 524, and the process ends in block 526.

The embodiment 500 illustrates a method that may be used by a controller in determining which route to send a message to a switched device. If the switch is set to the controller in block 506, the controller can communicate directly. If a condition is set so that another controller is the primary controller in block 508, a message is transmitted through the primary controller. Otherwise, the message is analyzed and sent on a route based on the analysis.

The default setting in block 508 may be made when the controllers are originally configured. For example, a device may have a primary controller that is tasked with handling a majority of the communications with the device. A majority of the requests for the device may be sent to the primary controller. In some cases it may be useful to require all communications to be sent through the primary controller as defined in block 508.

The message may be analyzed in block 516 in many different manners, as described above. Criteria may include the switchover time and the additional length of time required if the message were sent via the primary controller.

In some cases, the secondary controller may be required to set the switch back to the previous setting in block 524. When this case exists, the analysis of the message to send in block 516 may include multiplying the switchover time by two.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A system comprising:
a first controller;
a second controller connected to a first communication path to said first controller;
a device having a plurality of ports, a first port being connected to said first controller along a second path and a second port being connected to said second controller along a third path, said device being configured to communicate along said third path and requiring a configuration time to communicate along said second path;
wherein said first controller is adapted to determine that said device is configured to communicate along said third path, said first controller being further adapted to send a message to said device along said second path or said first and third paths using a predetermined criteria.

2. The system of claim 1 wherein said device is not capable of communicating on said second and said third paths simultaneously.

3. The system of claim 1 wherein said criteria comprises said configuration time and the length of said message.

4. The system of claim 1 wherein said criteria comprises a configuration setting.

5. The system of claim 1 wherein said device comprises a disk drive.

6. The system of claim 5 wherein said disk drive comprises only one port and said device comprises a switch connected to said one disk drive port and said second and third paths.

7. The system of claim 1 comprising a RAID system.

8. A disk storage system comprising:
at least one disk drive having multiple ports and being capable of communicating on one port at a time, said disk drive requiring a changeover time to switch from a first of said ports to a second of said ports;
a first controller connected to said first port of said disk drive through a first path;
a second controller connected to said second port of said disk drive through a second path and connected to said first controller through a third path, said second controller adapted to detect that said disk drive is switched to said first path and send a message to said disk drive through said third path and said first path based at least in part on a predetermined criteria.

9. The system of claim 8 wherein said criteria comprises said configuration time and the length of said message.

10. The system of claim 8 wherein said criteria comprises a configuration setting.

11. The system of claim 8 comprising a plurality of said disk drives.

12. The system of claim 11 wherein said controllers are RAID controllers.

13. A method for communicating from a first controller to a device having a first communication path to said first controller and a second communication path to a second controller, said first controller having a third communication path to said second controller, said method comprising:
determining that said device has a switchover time to switch from said second path to said first path;
determining that said device is switched to said second path;
evaluating a first message to send;
sending said first message to said device via said third path and said second path.

14. The method of claim 13 further comprising:
comparing the length of time required to send said message to said device via said third path and said second path to the time to send said message to said device via said first path plus said switchover time.

15. The method of claim 13 further comprising:
comparing the length of time required to send said message to said device via said third path and said second path to the time to send said message to said device via said first path plus two times said switchover time.

16. The method of claim 15 further comprising:
designating said second controller as the primary controller for said device.

17. The method of claim 13 wherein said device is a disk drive.

18. The method of claim 17 wherein said first and second controllers are RAID controllers.
